(19) United States
(12) Patent Application Publication
(10) Pub. No.: US 2013/0305936 A1
(43) Pub. Date: Nov. 21, 2013

(54) BALE PRESS AND METHOD FOR PRODUCING COMPACTED PRESSED BALES FROM FIBROUS MATERIAL

(71) Applicants: Dirk Falise, Kaufering (DE); Norbert Sauerwein, Augsburg (DE)

(72) Inventors: Dirk Falise, Kaufering (DE); Norbert Sauerwein, Augsburg (DE)

(21) Appl. No.: 13/982,069

(22) PCT Filed: Jan. 27, 2012
(86) PCT No.: PCT/EP12/51313

§ 371 Date: Jul. 26, 2013

(30) Foreign Application Priority Data
Jan. 28, 2011 (DE) 20 2011 000 205.5

(51) Int. Cl. B30B 9/30; B65B 63/02

(52) U.S. Cl. CPC B30B 9/301; B65B 63/02
USPC 100/35; 100/71

(57) ABSTRACT

A bale press (1) for compacted pressed bales (6) of fibrous material (7), in particular textile fibers, has a pressing device (8) with a compression box (12) and a filling device (9) with two parallel filling strands (10, 11), which serve for filling the compression box (12) with fibrous material (7). The multi-strand filling device (9) and the pressing device (8) operate on a cyclical basis. The compression box (12) is filled with multiple charges of fibrous material that are compacted individually or together.

### CROSS REFERENCE TO RELATED APPLICATIONS

This application is a United States National Phase Application of International Application PCT/EP2012/051313 filed Jan. 27, 2012 and claims the benefit of priority under 35 U.S.C. §119 of German Utility Model DE 20 2011 000 205.5 filed Jan. 28, 2011, the entire contents of which are incorporated herein by reference.

### FIELD OF THE INVENTION

The invention pertains to a bale press for compacted pressed bales from fibrous material, especially textile fibers, with the bale press having a pressing device with a compression box and a filling device for filling the compression box with fibrous material.

### BACKGROUND OF THE INVENTION

Such a bale press is known from DE 29 10 536. It is designed as a prepress with a compression box and filling device for filling the compression box with the fibrous material. The filling device has an individual filling box and a downstream, individual slide-in box, from which boxes the fibrous material fed is fed batchwise into the compression box and is compacted there. The bale press is designed here as a prepress, which is arranged together with a main press for the final compaction of the prepressed bales in a rotary press. The compression box with the prepressed bales is transported from the prepress to the main press with a rotary table.

DE 20 2005 014 028 U1 shows another bale press plant with a prepress and with a filling device, wherein prepressed bales are delivered by a pusher from the prepress into the press shaft or an adjacent main press. The main press has two pressure rams driven in opposite directions.

EP 0 907 498 B1 and EP 1 120 237 A2 show other bale presses with filling devices.

### SUMMARY OF THE INVENTION

An object of the present invention is to show another and improved bale press technique.

According to the invention, a bale press for compacted pressed bales of fibrous material, especially textile fibers, has a pressing device with a compression box and a filling device for filling the compression box with fibrous material. The filling device has a plurality of parallel filling strands.

The bale press technique according to the invention offers increased capacity due to the multi-strand compression box filling and the arrangement of a plurality of parallel filling strands. It can fill in and compact larger quantities of fibrous material than prior-art bale presses during an equal time.

These advantages become noticeable in all types of fibrous materials, especially in short cut fibers, so-called stable fibers. The higher filling and pressing capacity has an especially favorable effect in case of very loose fibrous materials with low bulk density, e.g., viscose fibers. The filling device can already bring about a first compaction of the fibrous material during the transfer of the fibrous material from the filling strands into a press shaft of the pressing device, and the pressing device carries out a further compaction of the precompacted fibrous material in the next step.

The increase in the capacity of the bale press compared to prior-art bale presses, which have only a single filling strand, can be utilized in a great variety of types and designs of bale presses. The bale press may be an individual press, which produces the completely pressed and compacted pressed bale. In the preferred embodiment being shown, the bale press is designed as a prepress and brings about precompaction of the pressed bale, which is subjected to final pressing in a downstream main press.

Such a bale press plant with one or more prepresses and with one or more main presses may be designed, e.g., as a rotary press or as a central press plant. The low-capacity prepress with only one filling strand represented the obstacle of the system in prior-art bale press plants compared to the main press, which usually had a markedly higher capacity. This handicap was eliminated by associating a plurality of prepresses operating staggered in time in relation to one another with a common main press, which entailed an increased design effort and logistic effort and a corresponding increase in the costs. The handicap could not be eliminated in rotary presses or other bale press plants with direct coupling of an individual prepress with an individual main press. The capacity of the plant was limited by the prepress. This obstacle can be eliminated with the bale press according to the invention and the multi-strand filling device, and only a low design effort and low cost is needed. The space requirement can also be kept small due to the association of a second, third or further filling strand. A bale press and a bale press plant of the type according to the invention therefore have not only a substantially higher performance, but are also more economical than the state of the art.

The present invention is shown schematically in the figures as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a front view of a bale press with a multi-strand filling device in an embodiment as a prepress and part of a rotary press;

FIG. 2 is a side view of the bale press according to arrow II in FIG. 1;

FIG. 3 is an enlarged and cut-away detail view of a detail of the filling device according to FIG. 1;

FIG. 4 is a top view of the bale press from FIGS. 1 and 2;

FIG. 5 is a side view of a packaging device for the pressed bales;

FIG. 6 is a schematic view of a variant of the bale press according to FIGS. 1; and

FIG. 7 is a sequence of the functions of the bale press according to FIG. 6 in 12 steps.

### DESCRIPTION OF THE PREFERRED EMBODIMENTS

Referring to the drawings in particular, the present invention pertains to a bale press (1) with a filling device (9) as well as to a corresponding pressing and filling method. The present invention pertains, furthermore, to a bale press plant (2) equipped with a bale press (1) and to a corresponding multistep pressing method as well as to a production method.

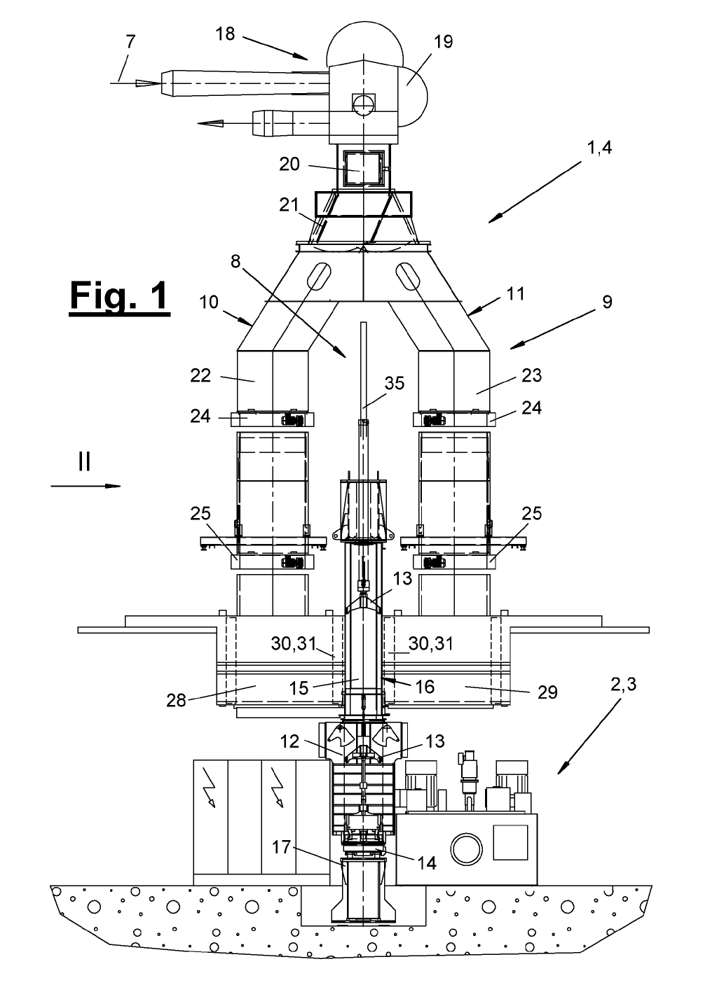

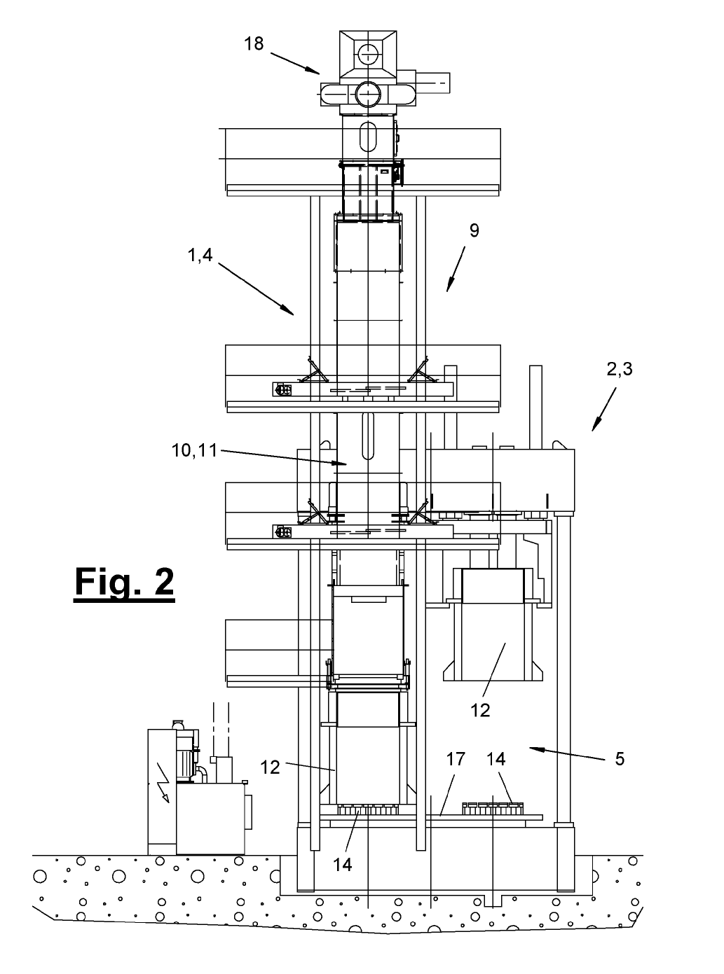

FIGS. 1 through 3 show different views of a bale press (1), which is designed in this embodiment as a prepress (4). The prepress (4) is part of a multistep bale press plant (2), which is designed as a rotary press in the embodiment being shown. The rotary press (3) has an individual prepress (4) and an individual main press (5) as well as a conveying device (17), which connects the two presses and is designed as a rotary table with a central vertical axis here.

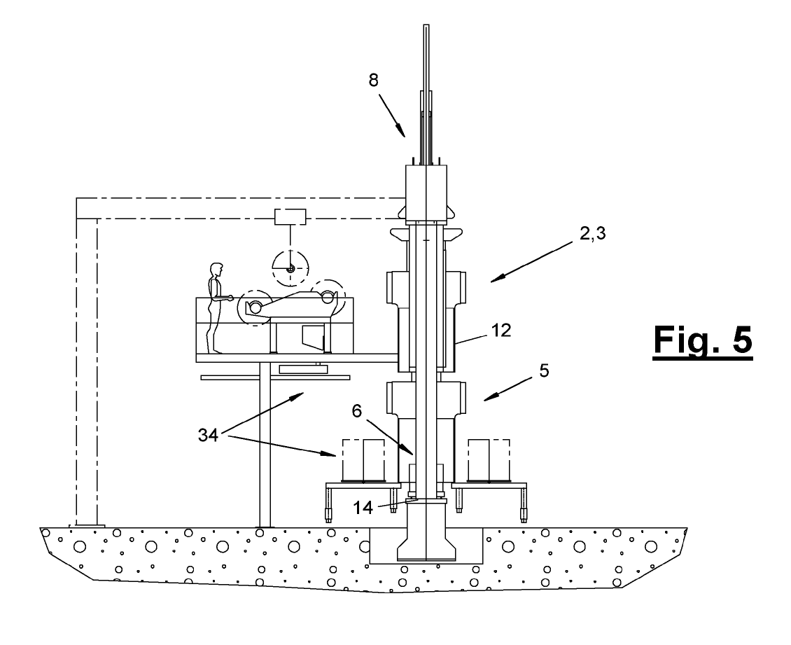

A pressed bale (6) is formed and pressed in the bale press (1) or prepress (4) from a fibrous material (7) fed from the outside, and this pressed bale (6) is then transported to the main press (5) and is subject to final pressing there under markedly higher pressures. The finished pressed bale (6) is packaged with a packaging device (34), which is shown, e.g., in FIG. 5.

The fibrous material (7) consists of textile fibers, which are preferably designed as synthetic fibers, but they may otherwise also be natural fibers or blends of synthetic and natural fibers. The textile fibers are intended for further industrial processing into nonwoven products, yarns or filaments or other similar textile products. The fibrous material (7) preferably consists of cut fibers, so-called staple fibers, which are cut off from a longer strand, wherein such fiber strands, e.g., so-called tows, are not excluded from use. The fibrous material (7) consists of short viscose fibers in the exemplary embodiment being shown.

The prepress (4) and the main press (5) have equal capacity or at least similar capacities in the rotary press (3) being shown, wherein a pressed bale (6) can be formed and prepressed in the prepress (4) and then subjected to final pressing in the main press (5) and possibly packaged during an essentially equal time period. Packaging may be uncoupled from the main press cycle.

The bale press (1) or the prepress (4) has a filling device (9) with a plurality of parallel filling strands (10, 11) and a pressing device (8), in which the pressed bale (6) is formed and precompacted.

The bale formation and compaction takes place in a compression box (12), which is arranged on the rotary table (17) in the exemplary embodiment of a rotary press (3) being shown and which is transported, especially rotated, together with the precompacted pressed bale (6) from the prepress (4) into the main press (5). The final pressing can take place here in the same compression box (12).

The compression box (12) has rigid walls and a tubular design in this embodiment, and it has, e.g., a prismatic, especially rectangular cross section. The main press (4) may have a means for removing the pressed bale (6) from the compression box (12). The baling press (1) may possibly also have such a means.

The pressing device (8) of the bale press (1) has an upper pressure ram and a lower pressure ram (13, 14) and a press drive (35), e.g., in the form of a hydraulic cylinder, for the mutual relative motion of the pressure rams (13, 14) and for compacting the pressed bale (6) formed between the pressure rams (13, 14) in the compression box (12). In the variant being shown, the lower pressure ram (14) is arranged stationarily on the rotary table (17) and the upper pressure ram (13) is moved up and down in the press shaft (15) by a piston rod or another drive element. The fibrous material (7) is filled into the press shaft (15) from the conveyed stands (10, 11) and is pushed by the upper pressure ram (13) into the compression box (12) located under the lower end of the press shaft and is compacted there. A pivotable retainer may be arranged at the compression box (12) for retaining the precompacted bale material.

The filling of the press shaft (15) as well as of the compression box (12) and bale formation take place on a cyclical basis and with the feeding and compaction of a plurality of batches of fibrous material. The upper pressure ram (13) is pulled upward each time and is again lowered after filling in the next batch of fibrous material, the material of the batch being introduced into the compression box (12) and compacted there.

The filling device (9) described below has two parallel filling strands (10, 11) in the embodiment being shown. The number of filling strands may also be greater and equal, e.g., three, four or more. The parallelism of the filling strands (10, 11) means that the filling strands (10, 11) can be charged with fibrous material (7) separately from each other and they release this fibrous material (7) to the pressing device (8) separately from each other.

The parallel filling strands (10, 11) are connected in the embodiment being shown to the pressing device (8), and they charge the pressing device (8) alternatingly or simultaneously. The filling strands (10, 11) have each a connection point of their own to the pressing device (8) and are arranged separately from one another in the embodiment being shown. The filling strands (10, 11) may be merged in front the pressing device (8) and then connected to the pressing device (8) together in a modified embodiment.

In the embodiment of the bale press (1) being shown, the filling device (9) and the pressing device (8) operate on a cyclical basis, wherein the compression box (12) is filled in the above-mentioned manner with a plurality of batches of fibrous material that are fed one by one and are subsequently compacted equally. Every individual batch of fibrous material is also compacted right away in the compression box (12) during feeding. A plurality of batches of fibrous material may be filled in one after another and compacted together with a compaction stroke, especially a precompression stroke, of the pressing device (8) at the end only in a modified embodiment.

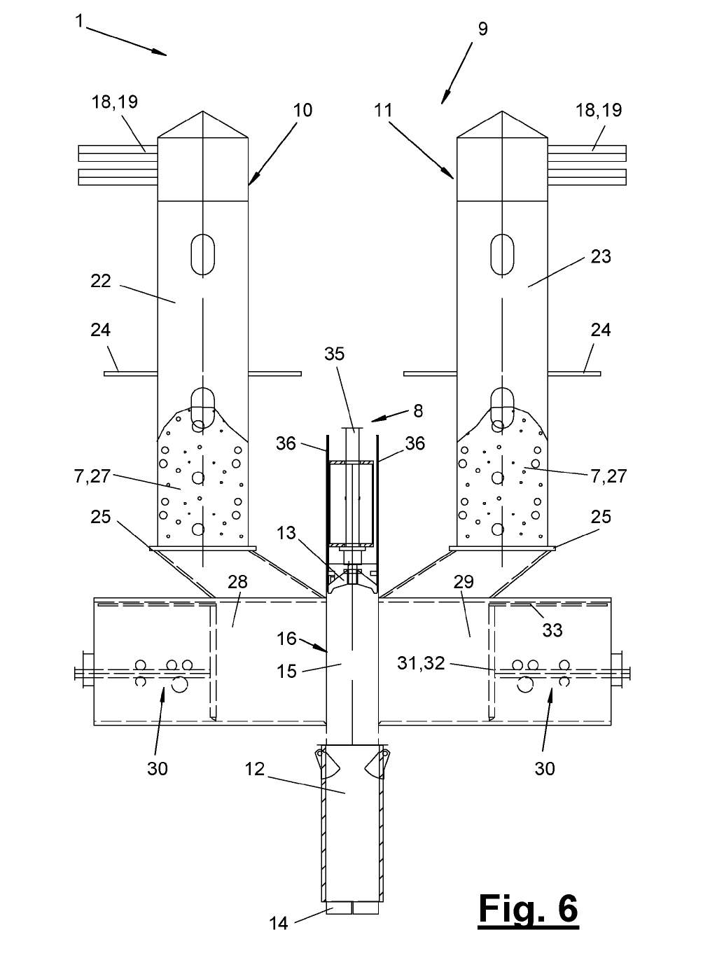

The filling strands (10, 11) may be of the same kind in the embodiments according to FIGS. 1 and 6. They have a collection shaft (22, 23) each and a filling shaft (28, 29) each adjoining in the direction of charging with a controllably driven filling pusher (30). Collection shaft (22, 23) has a vertical orientation and the filling shaft (28, 29) a horizontal orientation. Collection shaft (22, 23) is arranged here essentially vertically, and it may also have a slightly sloped oblique arrangement. Filling shaft (28, 29) is arranged essentially horizontally and may likewise have a slightly sloped orientation. In the filling shaft (28, 29), the fibrous material (7) falls down under its own weight into the adjoining filling shaft (28, 29), from which it is transported farther into the press shaft (15) with the filling pusher (30). Collection shaft (22, 23) may also have an oblique feed pipe at the lower end for connection to the filling shaft (28, 29), as this is shown as an example in FIG. 6.

Filling shaft (28, 29) of the filling strand (10, 11) always opens at the press shaft (15). In the embodiment being shown, the filling shafts (28, 29) of the filling strands (10, 11) open at different points of the press shaft. These opening points are preferably located at the same level. The filling shafts (28, 29) of two filling strands (10, 11) are arranged on both sides of the press shaft (15) and opposite each other at the same level. Mutually opposite filling shafts (28, 29) may open at different levels of the press shaft in a modified embodiment. Furthermore, it is possible to arrange the opening points of filling shafts (28, 29) diagonally. This is meaningful anyway if three or more filling shafts (28, 29) adjoin the press shaft (15).

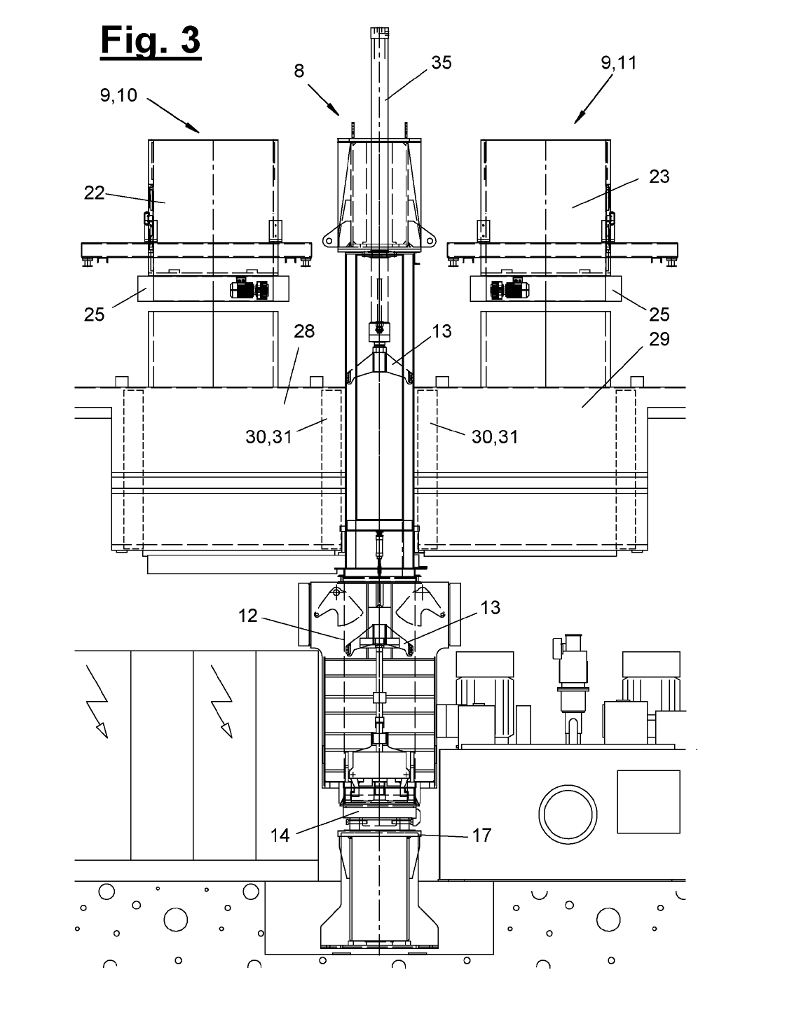

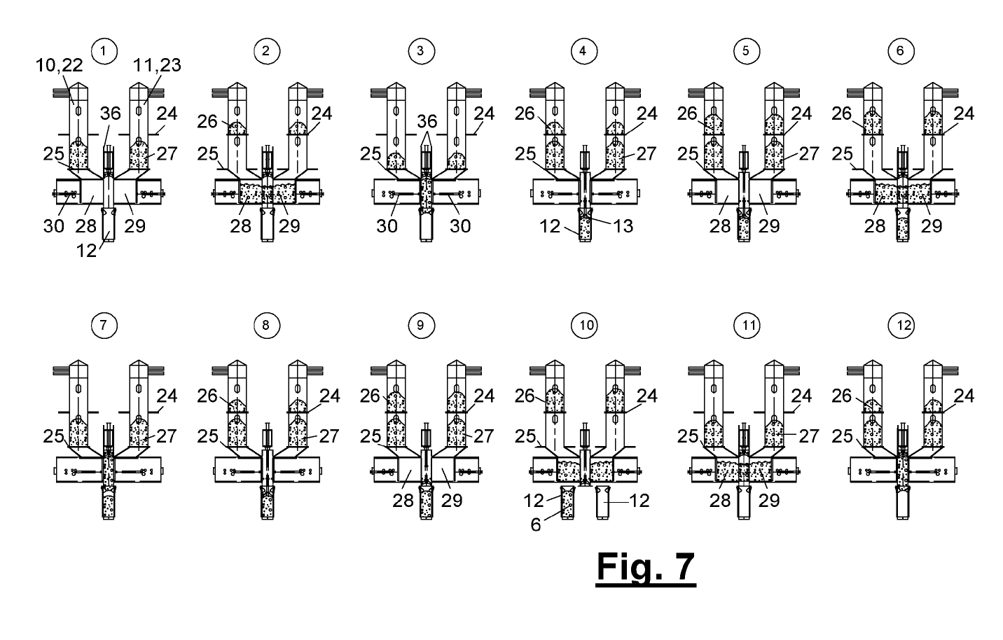

In the embodiments being shown, filling pusher (30) may have a pusher wall (31), which is directed along the preferably straight press shaft axis and which may form a part of the press shaft wall (16) in its front feed position. FIGS. 6 and 7 show the pusher wall (31) by solid lines. It is symbolized by rectangles drawn in broken lines in FIGS. 1 and 3.

The press shaft wall (16) may have movable auxiliary walls (36), which can open or close the corresponding shaft opening, at the opening points of the filling shafts (28, 29), and they are pulled up for opening, e.g., according to FIG. 6. The auxiliary walls (36) can be moved to a location in front of the pusher wall (31). The pusher wall (31) can have a pure transport and press function for the fibrous material (7) in such an embodiment, the auxiliary walls (36) being closed during the motion of the upper pressure ram (13) and forming a possibly guiding part of the press shaft wall (16).

According to the view shown in FIG. 6, pusher wall (31) may have an essentially vertical and preferably flat wall section (32), which transports and compacts the fibrous material (7) and which possibly forms said part of the press shaft wall (16). Pusher wall (31) may have, furthermore, a backwardly directed horizontal or oblique wall section (33), which adjoins the upper end of wall section (32), extends along the filling shaft wall and closes the opening point of the corresponding collection shaft (22, 23) in the feed position of the filling pusher (30).

Filling pusher (30) has a controllable drive. It may be designed, e.g., in the manner shown in EP 0 907 498 B1 as a friction wheel drive. Any other desirable drive constructions are possible as well.

In case of an arrangement of filling shafts (28, 29) at the same level as shown in the exemplary embodiments, the filling pushers (30) can deliver the fibrous material (7) into the press shaft (35) and also compact it there right away in a first pressing step under the pulled-up pressure ram (13). The quantities of fibrous material thus fed together form a batch of fibrous material or filling batch and are pushed by the pressure ram (13) into the compression box (12) and possibly subjected to further compaction there in a second pressing step.

It is favorable for the compaction if at least two filling shafts (28, 29) and filling pushers (31) are arranged mutually opposite each other and are actuated essentially simultaneously and are brought into the feed position at the press shaft (15). A feed staggered in time is also possible as an alternative, and the batch of fibrous material or filling batch is formed from two or more quantities of fibrous material fed in this case as well. These individual quantities of fibrous material are hereinafter called collected batches.

The remaining part of the press shaft wall (16) may be formed by stationary shaft walls. It is possible as an alternative to form the shaft wall (16) in this filling area essentially only from possibly bent pusher walls (31) and possibly filling shaft walls located between them.

The collection shafts (22, 23) of the filling strands (10, 11) are designed to form one or more collected batches (26, 27) of fibrous material (7). An upright collection shaft (22, 23) may have one or more movable collection floors (24, 25), the collection floors (24, 25) being arranged at different levels of the shaft in case of a multiple arrangement. The collection floor or collection floors (24, 25) may have an essentially horizontal orientation and can open or close the shaft opening point. They may be designed for this, e.g., as divided pushers according to FIG. 6. Working platforms are also arranged here.

Fibrous material (7) fed collects above the collection floor or collection floors (24, 25) in the closed position and forms a collected batch (26, 27), which is also called batch. Two batches (26, 27) can be formed one on top of another and staggered in time one after another in a collection shaft (22, 23) in the embodiments being shown. The number of batches may also be greater in a modified embodiment.

The filling device (9) and preferably each filling strand (10, 11) may have a weighing device (not shown), with which the weight of the fibrous material filled in can be determined. The desired weight of the pressed bale is obtained from the number of batches (26, 27) and the batches of fibrous material or filling batches formed therefrom. Metering is also possible here, so that the batch weights or the filling batch weights may differ from each other in order to maintain the desired pressed bale weight as accurately as possible by corresponding adjustment. The weighing device may be a one-part or multi-part device. It may also contain a measuring device for determining the weight of the pressed bale. A weighing device is arranged, e.g., on one or more collection floors (24, 25) and/or on the floor area of the filling shafts (28, 29). Furthermore, a suitable control and analysis device is present for processing the weighing results reported and possibly for metering.

The filling device (9) has a fibrous material feed unit (18), with which the fibrous material (7) is fed in a suitable manner. This may be brought about, e.g., in an air stream, wherein the fibrous material feed unit (18) has one or more condensers (19), with which the fibrous material (7) is separated from the air stream and transferred to the filling device (9).

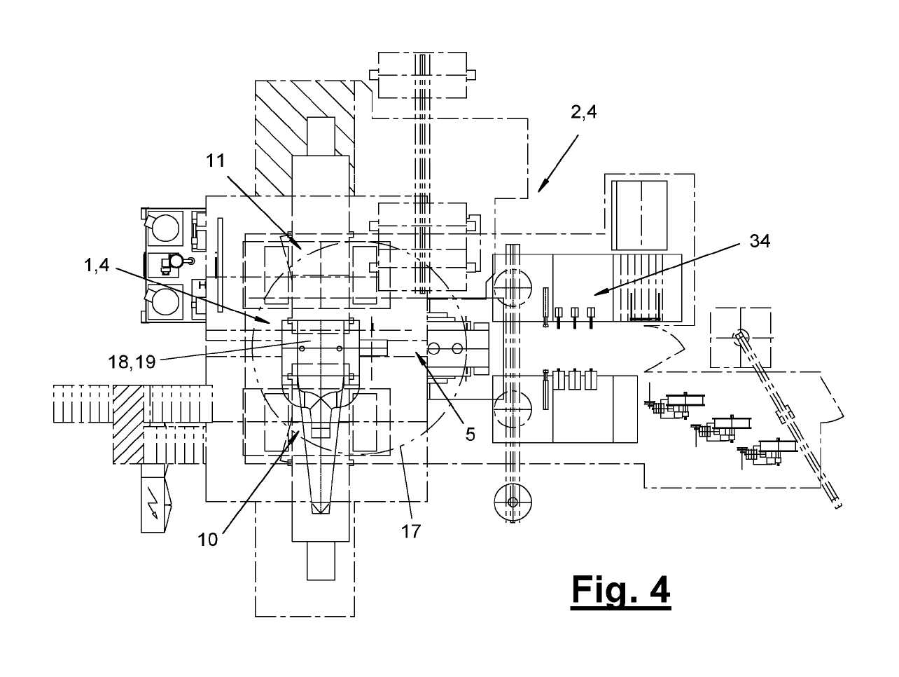

In the exemplary embodiment according to FIGS. 1 through 4, the filling device (9) has a feeding device (18), which is common for a plurality of or all filling strands (10, 11) and which has a branched feed shaft (20) with a controllable shunt (21). The fibrous material (7) can be transferred over this to the filling shafts (22, 23) in a controlled manner. Each strand (10, 11) has a feeding device (18) of its own, possibly with a condenser (19) of its own, in the exemplary embodiment according to FIGS. 6 and 7.

FIG. 7 shows the filling and pressing process of a bale press (1), which is designed, e.g., according to FIG. 6. The process steps shown are designated by numbers 1 through 12. The filling strands (10, 11) and their components operate, e.g., synchronously here.

Fibrous material (7) is fed in step 1 at the beginning of the process into both filling strands (10, 11) and the collection shafts (22, 23) thereof and collected on the closed lower collection floor (25), forming batches, with the upper collection floors (24) being opened. The filling shafts (28, 29) are empty and the auxiliary walls (36) are retracted.

The lower collection floors (25), which are located, e.g., at the kinking point between the vertical collection shaft area and the oblique feed pipe, are opened in step 2, and the two lower batches (27) are transferred into the filling shafts (28, 29) and also into the press shaft (15) opened by the retracted filling pushers (30) and auxiliary walls (36). The upper collection floors (24) are closed, so that upper batches (26) are again formed here.

The lower collection floors (25) close in step 3 and the upper collection floors (24) open, as a result of which the upper batch (26) drops down. It may grow due to more fibrous material (7) being fed continuously, until the desired lower batch size is reached. The two filling pushers (30) transport the batches from the filling shafts (28, 29) into the press shaft (15), forming the fibrous material batch or filling batch in the process and compress these. At the same time, they close the lower ends of the collection shafts (22, 23). The fibrous material or filling batch is held floating above the compression box (12) by the box retainer swung in.

The desired weight of the lower batch (27) is reached in step 4, and all collection floors (24, 25) are closed, and a new upper batch (26) is formed. The upper pressure ram (13) pushes the fibrous material or filling batch into the compression box (12) and compacts it there. The filling pushers (30) are in the feed position and form a part of the shaft wall (16).

The filling pushers (30) are retracted in step 5 into the starting position and all collection floors (24, 25) are closed, while compaction can proceed in compression box (12).

The lower collection floors (25) open in step 6, and the lower batches (27) are transferred into the filling shafts (28, 29) as well as into the press shaft (12), and the upper collection floors (24) with the new upper batches (26) are closed, The upper pressure ram (13) and the auxiliary walls (36) had again been retracted into the upper starting position before.

Similarly to what happens in step 3, the fibrous material or filling batch is formed in the press shaft (15) and compressed in step 7, and new lower batches (27) are formed on the closed lower collection floors (25). These are larger in step 7 than in step 3 because correspondingly large upper batches (26) were already collected in step 6.

The upper collection floors (24) are again closed in step 8 as soon as the desired lower batch size is reached, and this may partially overlap with the possibly still ongoing prepressing operation in the compression box (12).

The pressing of the fibrous material or filling batch in the compression box (12) is still going on in step 9, while the upper batches (26) on the closed upper collection floors (24) are growing.

Step 6 may again follow step 9 and the cycle may be repeated.

Unlike in step 6, the termination of the pressing operation, especially prepressing operation, after the filling and compaction of the last fibrous material or filling batch, is shown in step 10. As in the above-described step 6, the lower collection floors (25) are opened here and the lower batches (27) are transferred into the filling shafts (28, 29). The auxiliary walls (36) can close the opening points of the filling shafts (28, 29) in such a case, so that no fibrous material (7) can enter the press shaft (15). Pressure ram (13) may be in a lower position now, in which it is just above the compression box (12). Step 10 also illustrates the box change by means of the conveying device (17) or the rotary table, wherein the filled compression box (12) with the prepressed bale is transported to the main press (5) and a new, empty compression box (12) is placed under the press shaft (15).

The auxiliary walls (36) are opened and the pressure ram (13) is raised in step 11, and the fibrous material (7) can enter, as in step 1, the press shaft (15) from the filling shafts (28, 29). The lower collection floors (25) are closed and take up the upper batches (26) dropping down with the upper collection floors (24) being open.

Step 12 illustrates the repeated compaction of the fibrous material or filling batch in the press shaft (15) and the formation of new upper batches (26) by the closed upper collection floors (24), The cycle can then start again with step 4.

The main press (5) may have any desired and suitable design. It likewise has a plurality of pressure rams and a press drive and can also cooperate with the compression box (12). A main press (5) can be connected to an individual prepress (4) or to a plurality of prepresses via a conveying device (17), with a central press being formed in the second case and the compression boxes (12) with the prepressed bales (6) are transported, e.g., via overhead conveyors, transfer cars or the like, from the prepresses (4) to the common main press (5) individually or independently from one another.

In another embodiment, the compression box (12) can have movable box walls and be formed temporarily at the respective pressing site. Such an arrangement may be designed, e.g., according to DE 20 2005 014 028 U1, where the box wall is opened after prepressing and the pressed bale, which is moved preferably upwardly and downwardly, is pushed over into the main press. The pressing devices (8) of the prepress and main press have each lower stationary pressure rams (14) and upper pressure rams (13) that can be fed and to which pressing force can be admitted in the exemplary embodiments being shown. The kinematics of the pressure rams (13, 14) and of the press drive (35) can be modified in a variant of this embodiment. This may happen, e.g., according to DE 20 2005 014 028 U1 by both pressure rams (13, 14) being guided movably and provided with a press drive of their own. It is also possible in another variant that only the lower pressure ram (14) is movable and can be driven upward towards the upper, stationary pressure ram (13).

A packaging device (34) for a final-compacted pressed bale (6) is associated with the bale press (1). In order for the bale press (1) to also subject the bale (6) to final pressing, there is a direct association. In case of a division of the pressing process into prepresses and main presses (4, 5), the packaging device (34) is associated with the main press (5). It can be integrated into this main press or arranged next to it at a spaced location from and connected thereto via a conveyor. Packaging may comprise fixation and/or enveloping of the pressed bale (6). A fixing element may be applied, e.g., by strappings, which preferably happens in the main press (5) at the pressed bales (6) being held between the pressure rams. Enveloping may be omitted. As an alternative, an envelope may be applied in addition to fixation. It may also form a fixing element at the same time by holding onto the oppressed bale (6). An envelope is also formed from a plurality of films, e.g., from a bottom film and cover film and a lateral body belt, e.g., according to FIG. 5 and the packaging device (34) shown there. As an alternative, packagings consisting of a plurality of bags or hoods, especially stretching hoods pulled over the pressed bale (6) in the opposite direction, are possible as well.

The bale packaging may be integrated in a main press cycle, especially if the bale packaging takes place at the main press (5) and on the clamped pressed bale (6). Packaging may also be uncoupled from the main press cycle and take place externally at a locally separated packaging device,

Various modifications of the exemplary embodiments shown and described are possible. The number of filling strands (11, 11) may vary. This also applies to the mutual association and distribution of filling shafts (28, 29). A separate main press (5) may possibly be omitted. The shaft design of the filling strands (10, 11) with collection and filling shaft (22, 23, 28, 29) may vary, and a filling pusher may possibly also be eliminated, or a filling pusher (30) may have a different design.

While specific embodiments of the invention have been shown and described in detail to illustrate the application of the principles of the invention, it will be understood that the invention may be embodied otherwise without departing from such principles.

1. A bale press for compacted pressed bales of fibrous material the bale press comprising:
a pressing device with a compression box; and
a filling device for filling the compression box with fibrous material the filling device having a plurality of parallel filling strands wherein at least one of the filling strands has a collection shaft and a filling shaft with a controllably driven filling pusher.

2. (canceled)

3. A bale press in accordance with claim 1, wherein the parallel filling strands are connected to the pressing device, wherein they charge the pressing device alternatingly or simultaneously, wherein the parallel filling strands open above the compression box at a press shaft of the pressing device.

4. (canceled)

5. A bale press in accordance with claim 1, wherein the parallel filling strands each have a collection and weighing device forming fibrous material batches.

6. (canceled)

7. (canceled)

8. (canceled)

9. A bale press in accordance with claim 1, further comprising a filling pusher having a pusher wall forming a part of a press shaft wall in the feed direction.

10. A bale press in accordance with claim 9, wherein the press shaft wall has movable auxiliary walls at the opening points of the filling shafts.

11. (canceled)

12. (canceled)

13. A bale press in accordance with claim 8, wherein the filling shafts of two filling strands are arranged on both sides of the press shaft and opposite each other at the same level or at different levels.

14. (canceled)

15. A bale press in accordance with claim 1, wherein an upright collection shaft of a filling strand has one or more movable collection floors at different heights of the shaft.

16. (canceled)

17. (canceled)

18. (canceled)

19. A bale press in accordance with claim 1, further comprising a common fibrous material feed with a controllable shunt or separate fibrous material feeds for the filling strands.

20. A bale press in accordance with claim 19, wherein the fibrous material feed has a condenser.

21. A bale press in accordance with claim 1, wherein the pressing device has pressure rams movable in relation to one another and a controllable press drive.

22. A bale press in accordance with claim 1, wherein the bale press is designed to produce pressed bales from synthetic fibers, especially viscose fibers.

23. (canceled)

24. (canceled)

25. A bale press in accordance with claim 1, further comprising: a packaging device for a pressed bale associated with the bale press.

26. (canceled)

27. (canceled)

28. (canceled)

29. A bale press plant for highly compacted pressed bales from textile fibers, the bale press plant comprising:
one or more prepresses; and
at least one main press (5), wherein one of the prepress is designed as a bale press comprising a pressing device with a compression box and a filling device for filling the compression box with fibrous material, the filling device having a plurality of parallel filling strands wherein at least one of the filling strands has a collection shaft and a filling shaft with a controllably driven filling pusher.

30. A bale press plant in accordance with claim 29, wherein the bale press plant comprises one of a rotary press and a central press plant.

31. A bale press plant in accordance with claim 30, wherein the bale press plant has a packaging device for a final-compacted pressed bale.

32. A method for producing compacted pressed bales from textile fibers, the method comprising the steps of:
providing a bale press comprising a pressing device with a compression box and a filling device for filling the compression box with fibrous material, the filling device having a plurality of parallel filling strands;
filling the textile fibers by means of a filling device into the compression box; and
compacting the fibrous material with the pressing device, wherein the textile fibers is fed to the filling device by a plurality of parallel filling strands and are fed from a collection shaft and a filling shaft with a controllably driven filling pusher.

33. (canceled)

34. A method in accordance with claim 32, wherein one or more collected batches are formed in a filling strand from the textile fibers fed.

35. A method in accordance with claim 34, wherein collected batches formed from the textile fibers fed are weighed and metered.

36. A method in accordance with claim 35, wherein collected batches formed from the textile fibers fed are combined into filling batches and are brought into a press shaft.

37. A method in accordance with claim 36, wherein the pressed bale is packaged within or outside the bale press.
